(19) United States
(12) Patent Application Publication
(10) Pub. No.: US 2022/0331627 A1
(43) Pub. Date: Oct. 20, 2022

(54) ENGINE'S ANTI-COMBUSTION METHOD

(71) Applicant: A2Z Advanced Solutions Ltd., Yaven (IL)

(72) Inventor: Joseph BEN TSUR, Yavne (IL)

(21) Appl. No.: 17/641,906

(22) PCT Filed: Sep. 11, 2020
(86) PCT No.: PCT/IL2020/051000

§ 371 Date: Mar. 10, 2022

Related U.S. Application Data
(60) Provisional application No. 62/899,340, filed on Sep. 12, 2019.

(51) Int. Cl. A62C 3/06; A62C 3/07; B60K 15/04

(52) U.S. Cl. CPC A62C 3/065; A62C 3/07; B60K 15/04; B60K 2015/03256

(57) ABSTRACT

The present invention provides systems and methods for preventing fire outbreak and suppressing fire in liquid-fuel activated vehicles.

### FIELD OF THE INVENTION

The present invention relates to fire suppression. More particularly, to devices and methods for fire suppression of combustible liquid in confined spaces.

### BACKGROUND

Accidents involving vehicles are quite common, to the extent that nearly every driver at some time will be involved in a minor or major accident. A minor accident is defined herein as an accident that does not endanger life or limb, whereas a major accident is defined as an accident that is life endangering.

Physical bruising due to impact following a vehicle accident is an obvious result due to the extraordinary level of impact which the vehicle has been subjected to. However, accidents may involve also fire due to, e.g., combustibility and explosiveness of the vehicles' fuel. Various safety devices were developed over the years to reduce physical bruising, such as seat belts and airbags. However the outbreak of a fire or an explosion can have a disastrous effect upon the passengers of the vehicle as well as on nearby bystanders.

Fuel tank combustion of a vehicle pose a serious risk. Such combustion may result due to various situations, such as an accident, damage to the fuel tank for any reason that leads to leakage of fuel, penetration of a projectile to the fuel tank, external fire (that heats the fuel within the fuel tank and lead to its combustion), static electricity ignition during fueling, etc.

It is thus desirable to provide a fire prevention safety system for vehicles that prevents unintentional fuel combustion and leakage, e.g., following an extraordinary impact, or due to elevated temperature level, or both.

Various attempts have been made to reduce the risk of fuel tank combustion and prevention thereof. For instance, in aircrafts, the inside surface of the fuel tank and other compartments are covered with panels containing a frangible honeycomb structure filled with a fire suppressant substance, such that penetration/damage to the compartment causes the release of the fire suppressant that interferes with air reaching the fuel and acts to prevent a fire from starting as well as extinguishing any existing fire. However, in order for this technique to be effective, a substantive damage to the fuel tank is needed. U.S. Pat. No. 8,894,014 also describes a firing prevention structure of a fuel tank.

CN 203865181 provides a fireproof fuel tank, in which its components are wrapped by at least one fireproof heat-insulation set.

Other methods use devices that detect flames and automatically release a suppressant, such as freon. Such detection is usually done by infra-red and ultra-violet optical detectors and thermocouple heat detectors. However, these techniques require a lapse of time after fuel tank rupture and flame start, which means that the fire might get out of hand.

### SUMMARY

The present invention relates to a fire prevention system for vehicles for preventing fire in case of an emergency situation, said system comprising an inner tube 100 designed to be placed within a fuel tank 101 of the vehicle and pressed against the inner walls thereof, wherein the inner tube 100 comprises at least two openings—one designed to fit the fuel tank's entrance for allowing filling fuel, and another designed to fit the fuel tank's exit port for allowing fuel to exit the fuel tank 101 to the engine, wherein the inner tube 100 is flexible.

The present invention further provides an inner tube 100 designed to fit inside a fuel tank 101 of a vehicle, wherein the inner tube 100: (i) is designed to be pressed-against or attach-to the inner walls of the fuel tank; and (ii) comprises at least two openings—one designed to fit the fuel tank's entrance for allowing filling fuel, and another designed to fit the fuel tank's exit port for allowing fuel to exit the fuel tank 101 to the engine; wherein the inner tube 100 is flexible, thereby enabling the prevention of spillage of fuel from the fuel tank 101 in case of damage to the fuel tank 101.

The present invention further provides a method for preventing fire outbreak due to fuel spillage from a vehicle's fuel tank due to an emergency situation, the method comprising placing a flexible inner tube 100 as defined in any one of the preceding claims inside a fuel tank 101 of said vehicle, such that upon breakage/rupture of the fuel tank 101, e.g. due to an emergency situation, the inner tube 100 remains intact and prevents spillage of fuel from the fuel tank 101 thereby preventing fire outbreak.

### BRIEF DESCRIPTION OF DRAWINGS

FIG. 1 illustrates an embodiment of a fire-prevention system of the invention placed in a fuel tank.

FIG. 2 illustrates another embodiment of the fire-prevention system of the invention with sealing mechanisms.

FIGS. 3A-3B illustrate other embodiments of the fire-prevention system of the invention with sealing mechanisms and a controller associated therewith.

### DETAILED DESCRIPTION

In the following detailed description of various embodiments, reference is made to the accompanying drawings that form a part thereof, and in which are shown by way of illustration specific embodiments in which the invention may be practiced. It is understood that other embodiments may be utilized, and structural changes may be made without departing from the scope of the present invention.

The present invention relates to safety systems for vehicles such as automobiles, and specifically to safety systems that prevent outbreak or spread of fire in the vehicle (especially its fuel tank) following an emergency situation such as an accident, collision, other extraordinary impact, fire, excessive heat, or any combination thereof.

The term “vehicle” as used herein refers to any vehicle that is powered by liquid-fuel, such as, but not limited to, motorcycles, motorcars, airplanes, etc. Accordingly, the present invention provides a fire prevention systems for use in vehicles equipped with fuel tanks.

The best way to put out a fire is to prevent it from starting. This can be done in many ways, one of which is to prevent flammable substances to be exposed to heat and/or sparks. Notably, when an emergency situation occurs that involves fuel-driven vehicles, such as a car accident, there is a risk of damage to the vehicle's fuel tank and spillage of the flammable fuel therefrom, which might cause fire or feed an existing fire. Accordingly, it is advisable to prevent spillage of fuel from a vehicle's fuel tank in emergency situations.

Various known techniques and systems have been developed to prevent fire onset and to prevent fire spreading, such as introduction of volatile halocarbons, such as Halon 1301, into the fuel tank. Such halocarbons have excellent fire extinguishing capacity since they actively interfere with the chemical reactions taking place in the flame and effectively inhibit them. Other methods use inert gaseous diluents or mineral salts based-powders, which require relatively large amounts of substance to be effective since they need to envelops the flame and suppresses it. However, these and other techniques and systems have various disadvantage, such as being suitable for use in fuel tanks of private vehicles, being insufficiently effective, and/or are too expensive. As such a need exist for a simple and effective fire onset prevention system for vehicles, especially for private vehicles.

The present invention provides safety systems for preventing outbreak or spread of fire in a vehicle, especially the vehicle's fuel tank. In certain embodiments, the safety system of the invention is fully automatic (meaning no action is required from the driver) and is positioned mainly or completely inside the vehicle's fuel tank, meaning that the system does not interfere with other parts of the vehicle and can be mounted/assembled even in an assembled vehicle—directly in the fuel tank.

Accordingly, in a first aspect, the present invention provides an inner tube 100 designed to fit inside a fuel tank 101 of a vehicle, wherein the inner tube 100: (i) is designed to be pressed-against or attach-to the inner walls of the fuel tank; and (ii) comprises at least two openings—one designed to fit the fuel tank's entrance for allowing filling fuel, and another designed to fit the fuel tank's exit port for allowing fuel to exit the fuel tank 101 to the engine; wherein the inner tube 100 is flexible, thereby enabling the prevention of spillage of fuel from the fuel tank 101 in case of damage to the fuel tank 101.

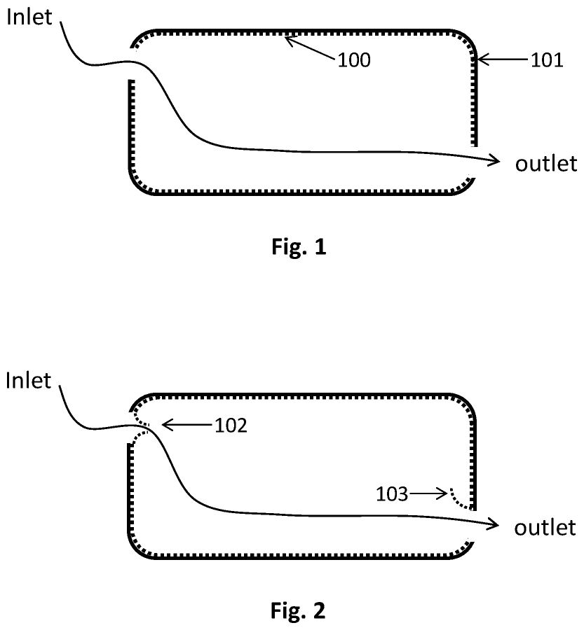

The present invention further provides a fire onset prevention system for vehicles for preventing fire in case of an emergency situation, said system comprising an inner tube 100 made of a material(s) that does not interact with the fuel, such as inert materials, the inner tube 100 is designed to be placed within a fuel tank 101 of the vehicle and pressed against or attached to the inner walls thereof, wherein: (a) the inner tube 100 comprises at least two openings—one designed to fit the fuel tank's entrance for allowing filling fuel, and another designed to fit the fuel tank's exit port for allowing fuel to exit the fuel tank 101 to the engine; and (b) the inner tube 100 is elastic/flexible, i.e. in order to enable the prevention of spillage of fuel from the fuel tank 101 in case of damage thereto, e.g. due to an impact. An exemplary system of the invention is illustrated in FIG. 1, in which the dotted line illustrates the inner tube 100 within the fuel tank 101. The flexibility of the inner tube 100 enables it to bend and prevents its breakage when the fuel tank's walls are bent or rupture, thereby enabling to maintain a sealed interior space inside the fuel tank 101 and thereby preventing spillage of fuel from the fuel tank 101.

The two openings at the inner tube 100 enable to maintain regular function of the fuel tank, i.e. by enabling regular filling of fuel and exit thereof to the engine.

The fire onset prevention system of the invention is intended to be used in vehicles equipped with liquid fuel tanks. Accordingly, the present invention provides a fire prevention systems for use in vehicles equipped with fuel tanks. The elasticity/flexibility of the inner tube 100 enables it to remain intact even when the hard shall of the fuel tank 101 is damaged for some reason, thereby enabling it to prevent spillage of the liquid fuel therefrom. Moreover, even if the fuel tank 101 and the inner tube 100 are pierced by a sharp object—the elasticity/flexibility of the inner tube 100 enables it to wrap around the penetrating object and thus prevent or almost completely eliminate fuel leak. Even if the penetrating object is removed, the inner tube 100 may return to its original orientation and shape, thereby reducing the opening through which fuel may exit.

The system of the invention is designed to be assembled both in existing vehicles and in vehicles during manufacture. To do that, a guiding element might be required in order to guide the inner tube 100 inside the fuel tank 101 while placing the openings in their right location/position. Accordingly, in certain embodiments, the fire prevention system of the invention further comprises a guiding cable designed to guide the flexible inner tube 100 during insertion thereof into the fuel tank 101.

The term “pressed against the inner walls” as used herein with reference to the placement of the inner tube 100 within the fuel tank 101, refers to any suitable procedure that enables placing the inner tube 100 so that it stays fixed to the inner walls of the fuel tank 101. Non-limiting examples of such procedure or method are gluing, welding, anchoring with screws and bolts or pins, etc. It also includes using structural elements embedded within the inner tube 100 (or the material it is made of) that prevent the inner tube 100 from collapsing inwardly after placement within the fuel tank 101 (and when fuel runs low).

In certain embodiments, the inner tube 100 of the invention further comprises an external adhesive layer designed, after its insertion to the fuel tank, to enable attachment of the tube's 100 exterior surface to the inner walls of the fuel tank 101 at one or more points thereof. The adhesive may be designed to be active, i.e. adhere, upon demand, namely after insertion and proper placement in the fuel tank 101.

In further embodiments, the inner tube 100 of the invention further comprises, either as add-on or as an integral part thereof, elements or sections made of a shape-memory material designed to maintain the inner tube 100 in an open form once placed inside the fuel tank 101. Alternatively, or in addition, the inner tube 100 itself is made of such shape-memory material. This enables folding the inner tube 100 to enable it to fit into the fuel tank 101 via one of its openings, and then expand into full open state to fit the inner walls of the fuel tank 101.

In certain embodiments, the fire onset prevention system of the invention is not connected to the fuel tank 101 and is only placed inside it without being physically and permanently attached/anchored to the inner walls thereof. In such configuration, the system may be comprised or consist of shape-memory material(s) that maintain the system in an open state after being placed in the fuel tank. In alternative embodiments, the system is secured/anchored to the fuel tank in at least one point. In specific embodiments, the anchoring point is at the fuel tank entrance or exit, or both. In this configuration, when only one or two anchoring points are being used, the system may further comprise or consist of shape-memory material(s) that assist in maintaining the system in an open state after being placed in the fuel tank. Such configurations enable flexibility of the system such that upon impact or collision it is free to bend and detach from the walls of the fuel tank without breaking thereby preventing spillage of the fuel in case of structural damage to the fuel tank. In further alternative embodiments, the system is secured/anchored to the fuel tank in one or multiple anchoring points, such as at the fuel tank entrance or exit and/or at various points throughout the fuel tank.

The presence of a flexible inner tube 100 within a fuel tank provides the fuel tank 101 with an elastic layer that provides another layer of protection so that even in the case that the walls of the fuel tank (its exterior) is broken or damaged, the inner flexible tube remains whole and does not break thanks to its flexibility, thereby preventing leakage of fuel even when the fuel tank's exterior is damaged.

The term “flexible” as used herein throughout the application refers to materials that are capable of bending or can be easily bent without breaking. Such materials are characterized in that they have the ability to deform elastically and return to its original shape when the applied stress is removed. Such flexibility enables the inner tube 100 of the invention to bend without breaking in case the fuel tank 101 is crushed or damaged due to, e.g. an impact. Such flexibility enables further enables the inner tube 100 to be folded for insertion into a fuel tank 101 and then return into its original open-form while being pressed against the inner walls of the fuel tank 101 while retaining its original form and not collapse inwardly.

Some advantages of the safety fire prevention systems of the present invention include: does not interfere with normal function of the vehicle, and does not occupy much space in the fuel tank; no power needed; simple and easy installation; computability to all vehicle types; no maintenance; long shelf life; and an immediate effect in case of an emergency situation.

The placement of the inner tube 100 inside the fuel tank 101 can be carried out at any given time point: for existing vehicles it can be inserted via the fuel inlet (after emptying the fuel tank from fuel) and, e.g., inflated to occupy the entire space of the fuel tank 101. For newly constructed vehicles, it may be incorporated into the fuel tank 101 during its manufacturing, using any suitable protocol. Another possible way to place the inner tube 100 inside the fuel tank 101 can utilize its flexibility, by folding the inner tube 100 for insertion into a fuel tank 101, such that when it enters the fuel tank 101 it returns to its original open-form and pressed against the inner walls of the fuel tank 101 while retaining its original form and not collapse inwardly. Another option is to use a guiding cable/wire that assists in leading the inner tube 100 into the fuel tank 101 while positioning the openings of the inner tube in their right orientation at the fuel tank's openings. Such a guiding cable/wire may be an integral part of the system of the invention.

Notably, a standard fuel tank has at least two openings: one for filling the fuel and another for fuel to exit to the motor. Accordingly, it is advisable that the inner tube 100 of the invention also comprise certain sealing elements that prevent spillage of fuel from such openings.

Thus, in certain embodiments of the fire prevention system of the invention, the opening designed to fit the fuel tank's entrance is a one-way valve allowing fuel to enter but not exit. In alternative embodiments, and as illustrated in FIG. 2, the fire prevention system of the invention further comprises a sealing mechanism 102 for the opening designed to fit the fuel tank's entrance, which is adapted to close said opening in case of an emergency situation. In specific embodiments, the fire prevention system of the invention further comprises a sealing mechanism 103 for the opening designed to fit the fuel tank's exit port, which is adapted to close said opening in case of an emergency situation. The fitting of the tube's openings to the fuel tank's opening is such that it does not interfere with standard operation and other connections thereof, e.g. with fuel pipes and fuel tank's lid.

The sealing mechanisms 102,103 are designed to prevent fuel from exiting through the original openings of the fuel tank 101. In specific embodiments, these sealing mechanisms 102,103 are automatic and are activated due to, e.g. a collision, or can be activated, e.g., via a detector(s), due to activation of the vehicle's airbag, due to increased temperature or identification of fire onset. These sealing mechanisms 102,103 can also be arranged to operate only when certain impact conditions and high temperature are identified. In specific embodiments, these sealing mechanisms 102,103 are activated manually by, e.g., the driver, a passenger, or a rescue personal present on site.

For example, impact conditions are sensed by a distortion sensing unit that may be located either inside the fuel tank 101, e.g. integrated in the inner tube 100, or outside the fuel tank 101, e.g. within a controller 104, but in any case the distortion sensing unit is associated with the controller 104 and/or the sealing mechanisms 102,103. In certain embodiments, the distortion sensing unit is arranged to react to a distortion, deformation or rupture of some surface portion of the fuel tank 101.

In other examples, temperature conditions may be sensed by a thermal device, either incorporated in the inner tube 100 inside the fuel tank, or placed anywhere else while being associated with the controller 104 and/or the sealing mechanisms 102,103.

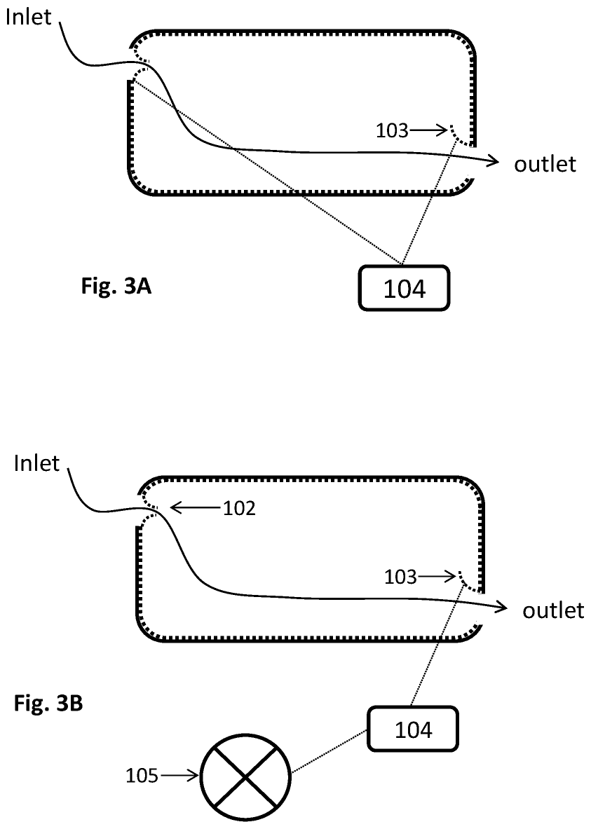

Accordingly, in specific embodiments, and as illustrated in FIG. 3, the fire prevention system of the invention further comprises a controller 104 associated with said sealing mechanism(s) 102,103 and designed to activate it and close said opening in case of an emergency situation. In further or alternative specific embodiments, the fire prevention system of the invention further comprises at least one sensor for detecting an emergency situation, e.g. an accelerometer for detecting a crash, and/or a thermometer for detecting a fire or excessive heat, and designed to activate said sealing mechanism(s) 102,103, either directly or via a controller 104. In specific embodiments thereof, the sensor or controller 104 is the vehicle's airbag system 105, such that activation of the airbag causes the sealing mechanism(s) 102,103 to close said opening. In specific embodiments, the at least one sensor is an integral part of the internal tube 100. Alternatively, or in addition, sensors can be external to the fuel tank 101.

In alternative embodiments, the sealing mechanism(s) 102,103 are connected, wirely or wirelessly, with a controller, e.g. the vehicle's computer or another controller thereof, wherein the controller is adapted to activate the sealing mechanism(s) 102,103 and close the opening(s) in case of an emergency situation.

In further alternative embodiments, the sealing mechanism(s) 102,103 are connected-to/associated-with at least one sensor for detecting an emergency situation, and/or a thermometer for detecting a fire or excessive heat, wherein such sensor(s) is adapted to directly activate the sealing mechanism(s) 102,103 and close the opening(s) in case of an emergency situation.

Notably, in certain embodiments, the system of the invention is designed to be associated with the vehicle safety mechanisms/systems, such as the safety belts and/or the airbag system 105. In such cases, the activation of such safety mechanisms/systems triggers closure of the sealing mechanisms 102,103, either directly or via a controller 104. In specific embodiments, the controller 104 is designed to identify the severity of the emergency situation that caused the activation of the vehicle's safety mechanisms/systems, and to determine whether or not to close the sealing mechanisms 102,103. In alternative embodiments, the controller 104 receives data from both the vehicle's safety mechanisms/systems and other sensors, such as s temperature sensor.

Accordingly, in specific embodiments of the fire prevention system of any of the embodiments above, and as illustrated in FIG. 3B, the controller 104 is associated with the vehicle's airbag system 105, such that activation of the airbag also activates the controller 104 to close the sealing mechanisms 102,103.

Since the inner tube 100 is in direct contact with fuel, it should be made of or coated with a material that is resistant to corrosion, erosion or any other reaction when exposed to the specific type of fuel being used. Accordingly, in certain embodiments of the prevention system according to any of the embodiments above, the inner tube 100, as well as the sealing mechanisms 102,103 if present, are made-of or coated-with material(s) that do not react with the intended fuel and do not dissolve thereby. Non-limiting examples of such materials are nitrile (e.g., nitrile rubber), neoprene, rubber and silicone. Notably, the inner tube may be made of a single material or of layers of different materials for, e.g. increased strength or durability or heat insulation. For instance, the inner tube may be made of several layers of nitrile separated from one another by layers of fabric. In specific embodiments, the inner tube 100, and the sealing mechanisms 102,103 if present, are heat resistance and/or heat insolated, or are made of such materials. In such embodiments, the presence of the inner tube further serves as heat insolation that improves the tank resistance to external heat/fire.

In certain embodiments, the system according to any of the embodiments above further comprises a freon container designed to release freon into the fuel tank upon detection of an emergency situation. The freon container may be positioned completely within the fuel tank, or alternatively be placed outside, completely or partially, the fuel tank, with an outlet located within the fuel tank such as to allow freon to be released from the container and into the fuel tank when needed.

In certain embodiments of the system according to any of the embodiments above, the inner tube 100 is made of a material(s) that in response to external heat undergoes chemical modification for increasing the strength of the tank walls

The term “emergency situation” as used herein throughout the application refers to any situation that is life threatening and involves a vehicle. Non-limiting examples are an accident, a collision, an extraordinary impact, a fire, excessive heat, or any combination thereof.

The present invention further provides a method for preventing fire outbreak due to fuel spillage from a vehicle's fuel tank due to an emergency situation, the method comprising placing a flexible inner tube 100 as defined in any one of the preceding claims inside a fuel tank 101 of said vehicle, such that upon breakage/rupture of the fuel tank 101, e.g. due to an emergency situation, the inner tube 100 remains intact and prevents spillage of fuel from the fuel tank 101 thereby preventing fire outbreak.

As explained above, the step of placing the inner tube 100 inside the fuel tank 101 can be carried out at any given time point: for instance, for existing vehicles it can be inserted via the fuel inlet (after emptying the fuel tank from fuel) and, e.g., inflated to occupy the entire space of the fuel tank 101. For newly constructed vehicles, it may be incorporated into the fuel tank 101 already during the engine's manufacturing, using any suitable protocol. Alternatively, the flexible inner tube 100 is placed inside the fuel tank 101 by folding it for insertion into a fuel tank 101, such that when it enters the fuel tank 101 it simply returns to its original open-form and is pressed against the inner walls of the fuel tank 101 while retaining its original form and not collapsing inwardly. Accordingly, in specific embodiments of the method of the invention, the step of placing the inner tube 100 in the fuel tank 101 is carried out in an existing fuel tank 101. In alternative specific embodiments the step of placing the inner tube 100 in the fuel tank 101 is carried out in a fuel tank 101 during its manufacturing.

As explained above, since the fuel tank has at least two openings: one for filling the fuel and another for fuel to exit to the motor, and as such the inner tube 100 of the invention will most likely also have certain sealing elements that prevent spillage of fuel from such openings. Accordingly, in certain embodiments of the method of the invention, when the inner tube 100 comprises at least one sealing mechanism 102,103 and optionally a controller 104, the method further comprises a step of associating the inner tube 100 or its controller 104 with the vehicle's airbag system 105, such that activation of said airbag also closes said at least one sealing mechanism 102,103. If the controller 104 is present, the airbag activates said sealing mechanism(s) 102,103 by activating the controller 104. In specific embodiments, the activation of the sealing mechanism 102,103 is automatic, i.e. in response to an emergency situation that is detected by sensors associated with said controller 104 and/or due to the activation of the vehicle's airbag 105. In further specific or alternative embodiments, the activation of the sealing mechanism 102,103 is also manual, i.e. by a user in response to an emergency situation.

In specific embodiments, the system and method of the invention comprise an arrangement, wherein the controller 104 or an alternative manual mechanism, such as a lever or button, are positioned near the driver to enable manual control thereby, for closing the sealing mechanism 102,103 according to the driver's desire/need. Accordingly, in certain embodiments of the system and method of the invention, the closing of the sealing mechanism 102,103 is manual, i.e. by a user in response to an emergency situation. Alternatively, or in addition, the closing of the sealing mechanism 102,103 is automatic, i.e. in response to an emergency situation that is, e.g., detected by sensors associated with a controller 104 and/or due to the activation of the vehicle's airbag 105.

In specific embodiments, the method further comprises a step of connecting the sealing mechanism(s) 102,103 (and/or the controller 104) to at least one sensor for detecting an emergency situation, and/or a thermometer for detecting a fire or excessive heat, wherein said at least one sensor is either a part of the system of the invention or not, and is adapted to activate said sealing mechanism(s) 102,103 directly (or via the controller 104 when present) and close said opening(s) in case of an emergency situation.

In certain embodiments, the method of the invention further comprises a step of associating a freon container to the interior of the fuel tank, such that in response to an emergency situation that is detected by sensors associated with the freon container, freon is automatically discharged into the fuel tank. The freon container may be positioned completely within the fuel tank. Alternatively, it may be placed outside, completely or partially, the fuel tank, with an outlet located within the fuel tank to allow freon to be released into the fuel tank.

Various improvements of the methods and systems of the present invention are possible. For instance, the system may be connected to pipes in the fuel system and/or oil system, such that upon activation thereof the flow of fuel and/or oil in the engine stops to thereby minimize the amount of potential fire-fuel, which reduces the risk of fire.

Another improvement is associating the system with an external fire extinguishing system that is designed to cool the engine area and/or spread fire suppressant(s) outside the fuel tank. Examples of cooling materials are coolant air, nitrogen, carbon dioxide, water, aqueous solutions of sodium salts and potassium salts, etc.

Although the invention has been described in detail, nevertheless changes and modifications, which do not depart from the teachings of the present invention, will be evident to those skilled in the art. Such changes and modifications are deemed to come within the purview of the present invention and the appended claims.

1. A fire prevention system for vehicles for preventing fire in case of an emergency situation, said system comprising an inner tube designed to be placed within a fuel tank of the vehicle and pressed against or attached to the inner walls thereof, wherein:
the inner tube comprises at least two openings—one designed to fit the fuel tank's entrance for allowing filling fuel, and another designed to fit the fuel tank's exit port for allowing fuel to exit the fuel tank to the engine, wherein the inner tube is flexible, thereby enabling the prevention of spillage of fuel from the fuel tank in case of damage to the fuel tank.

2. The fire prevention system of claim 1, further comprising a guiding cable designed to guide said flexible inner tube during insertion thereof into the fuel tank.

3. The fire prevention system of claim 1, wherein said inner tube further comprises an external adhesive layer designed to attach the inner tube's exterior surface to one or more points of the inner walls of the fuel tank.

4. The fire prevention system of claim 1, wherein said inner tube 100 is made-of or further comprises a shape-memory material designed to maintain the inner tube in an open form once placed inside the fuel tank.

5. The fire prevention system of claim 1, wherein the opening designed to fit the fuel tank's entrance is a one-way valve allowing fuel to enter but not exit.

6. The fire prevention system of claim 1, further comprising a sealing mechanism for said opening designed to fit (i) the fuel tank's entrance or (ii) the fuel tank's exit port, or both, adapted to close said opening(s) in case of an emergency situation.

7. The fire prevention system of claim 6, wherein said sealing mechanism(s) is: (i) connected with a controller that is adapted to activate said sealing mechanism(s) and close said opening(s) in case of an emergency situation; or (ii) connected to at least one sensor for detecting an emergency situation, and/or a thermometer for detecting a fire or excessive heat, wherein said at least one sensor is adapted to activate said sealing mechanism(s) and close said opening(s) in case of an emergency situation.

8. The fire prevention system of claim 6, further comprising: (i) a controller associated with said sealing mechanism(s) and designed to activate it and close said opening(s) in case of an emergency situation; or (ii) at least one sensor for detecting an emergency situation, and/or a thermometer for detecting a fire or excessive heat, and designed to activate said sealing mechanism(s), either directly or via a controller.

9. (canceled)

10. (canceled)

11. The fire prevention system of claim 8, wherein said sensor or controller is the vehicle's airbag system, such that activation of the airbag causes the sealing mechanism(s) to close said opening(s).

12. The fire prevention system of claim 8, further comprising a freon container designed to release freon into the fuel tank upon detection of an emergency situation.

13. The fire prevention system of claim 1, wherein said inner tube is made of a material(s) that: (i) does not react with the fuel and does not dissolve thereby; (ii) is heat resistance and/or heat insolated; or (iii) in response to external heat undergoes chemical modification and hardens thereby increasing the strength of the fuel tank's walls.

14. (canceled)

15. (canceled)

16. (canceled)

17. A fuel tank comprising the fire prevention system of claim 1.

18. The fuel tank of claim 17, wherein said inner tube is: (i) not connected to the fuel tank; or (ii) connected to the fuel tank at one or more points.

19. (canceled)

20. An inner tube designed to fit inside a fuel tank of a vehicle, wherein the inner tube: (i) is designed to be pressed-against or attach-to the inner walls of the fuel tank; and (ii) comprises at least two openings—one designed to fit the fuel tank's entrance for allowing filling fuel, and another designed to fit the fuel tank's exit port for allowing fuel to exit the fuel tank to the engine;
wherein the inner tube is flexible, thereby enabling the prevention of spillage of fuel from the fuel tank in case of damage to the fuel tank.

21. A method for preventing fire outbreak due to fuel spillage from a vehicle's fuel tank due to an emergency situation, the method comprising placing a flexible inner tube as defined in claim 1 inside a fuel tank of said vehicle, such that upon breakage/rupture of the fuel tank's wall the flexible inner tube remains intact to thereby prevent spillage of fuel from the fuel tank and thus preventing fire outbreak.

22. The method of claim 21, wherein said tube is placed within: (i) an existing fuel tank, optionally using a guiding cable; or (ii) a fuel tank 101 during manufacturing thereof.

23. (canceled)

24. The method of claim 21, wherein the inner tube further comprises at least one sealing mechanism and optionally a controller, and the method further comprises a step of: (i) connecting the inner tube or its controller with the vehicle's airbag system, such that activation of said airbag also closes said at least one sealing mechanism, via the controller when present; or (ii) connecting said at least one sealing mechanism and/or said controller to at least one sensor for detecting an emergency situation, and/or a thermometer for detecting a fire or excessive heat, wherein said at least one sensor is adapted to activate said sealing mechanism(s) directly or via the controller when present and close said opening(s) in case of an emergency situation.

25. (canceled)

26. The method of claim 24, wherein the activation of the sealing mechanism is: (i) automatic, i.e. in response to an emergency situation that is detected by sensors associated with said controller and/or due to the activation of the vehicle's airbag; or (ii) manual, i.e. by a user in response to an emergency situation.

27. (canceled)

28. The method of claim 21, further comprising a step of associating a freon container to the interior of the fuel tank, such that in response to an emergency situation that is detected by sensors associated with said freon container, freon is automatically discharged into the fuel tank.

29. The method of claim 21, wherein said emergency situation is selected from an accident, a collision, an extraordinary impact, a fire, excessive heat, or any combination thereof.
